(19) United States
(12) Patent Application Publication
(10) Pub. No.: US 2013/0283569 A1
(43) Pub. Date: Oct. 31, 2013

(54) Safety Hinge Mechanism

(71) Applicant: Chiu-Hung Lin, Taichung City (TW)

(72) Inventor: Chiu-Hung Lin, Taichung City (TW)

(21) Appl. No.: 13/459,353

(22) Filed: Apr. 30, 2012

(51) Int. Cl. E05D 11/10

(52) U.S. Cl. 16/319

(57) ABSTRACT

A safety hinge mechanism includes first and second joining structures, an engaging member, and a biasing member. The second joining structure is pivotally joined to the first joining structure. The engaging member is biased by the biasing member. The first joining structure includes a plurality of first engaging structures. The engaging member includes a plurality of second engaging structures selectively engaged with the plurality of first engaging structures. The engaging member is axially movable between the first and second joining structures.

### BACKGROUND OF THE INVENTION

1. Field of the Invention

The present invention relates to a hinge mechanism and, particularly to, a safety hinge mechanism.

2. Description of the Related Art

TW Patent No. 85183 shows a foldable cradle. The foldable cradle includes a plurality of struts. When the foldable cradle is in an extended position, a bed board can be placed. The bed board can prevent the foldable cradle from being folded. When the foldable cradle is in a collapsed position, it is thus folded. While this foldable cradle includes a plurality of strut joints and includes each strut joint for interconnecting two of the plurality of struts and allowing the struts interconnected therewith to pivot with respect to one another, these strut joints don't have safe mechanisms to prevent a user from being pinched and have many pinch points that are likely to catch or trap any part of a user's body consequently.

The present invention is, therefore, intended to obviate or at least alleviate the problems encountered in the prior art.

### SUMMARY OF THE INVENTION

According to the present invention, a safety hinge mechanism includes first and second joining structures, an engaging member, and a biasing member. The first joining structure defines a first hinge end. The first hinge end includes an inner periphery including a plurality of first engaging structures. Each of the plurality of first engaging structures is in the form of a one-way clutch tooth. The second joining structure defines a second hinge end. The second hinge end is pivotally joined to the first hinge end. The engaging member is axially movable between the first and second joining structures and includes an outer periphery including a plurality of second engaging structures selectively engaged with the plurality of first engaging structures. Each of the plurality of second engaging structures is in the form of a one-way clutch tooth. The engaging member is biased by the biasing member. The engaging member is movable to a first position in which the first and second engaging structures are engaged with and rotatable relative to one another in a first direction and anti-rotatable in a second direction reverse to the first direction and to a second position in which the first and second engaging structures are disengaged from one another and rotatable relative to one another in both the first and second directions.

The safety hinge mechanism is able to be extended and prevented from being collapsed when the engaging member is in the first position.

The safety hinge mechanism is able to be extended and collapsed when the engaging member is in the second position.

Other objects, advantages, and new features of the present invention will become apparent from the following detailed description of the invention when considered in conjunction with the accompanied drawings.

### BRIEF DESCRIPTION OF THE DRAWINGS

FIG. 1 is a perspective view of a safety hinge mechanism in accordance with the present invention.

FIG. 2 is an exploded perspective view of the safety hinge mechanism shown in FIG. 1.

FIG. 3 is a cross-sectional view taken along line 3-3 of FIG. 1, showing the safety hinge mechanism in a first mode.

FIG. 4 is a cross-sectional view showing the safety hinge mechanism in a second mode.

FIG. 5 is another cross-sectional view showing the safety hinge mechanism in the second mode.

FIG. 6 is a perspective view showing the safety hinge mechanism in a folded position.

FIG. 7 is a cross-sectional view taken along line 7-7 of FIG. 6.

FIG. 8 is a cross-sectional view taken along line 8-8 of FIG. 6.

FIG. 9 is a partial cross-sectional view of FIG. 6.

FIG. 10 shows the safety hinge mechanism in an operation of being unfolded.

FIG. 11 shows a cradle in a safe extended position using the safety hinge mechanism of the present invention.

FIG. 12 shows the cradle of FIG. 11 in a safe collapsed position using the safety hinge mechanism of the present invention.

### DETAILED DESCRIPTION OF INVENTION

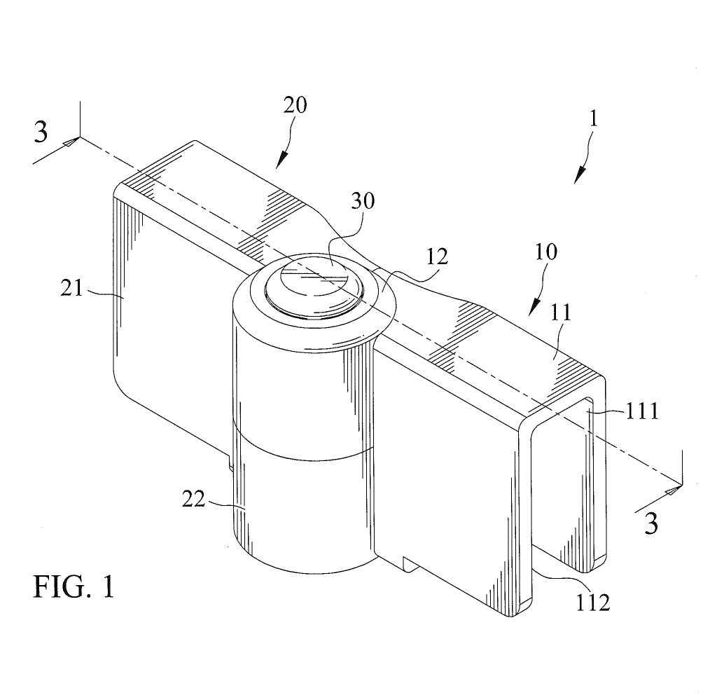

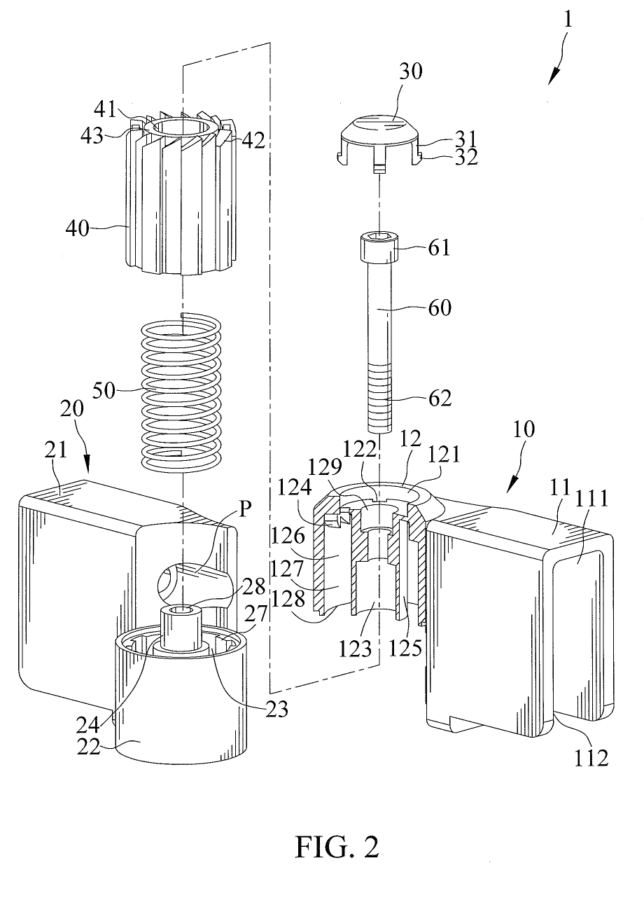

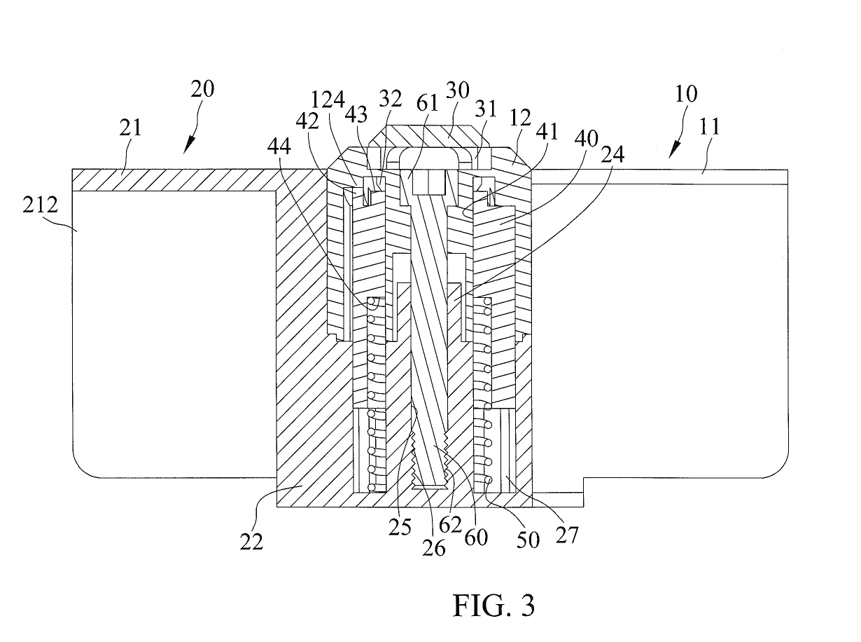

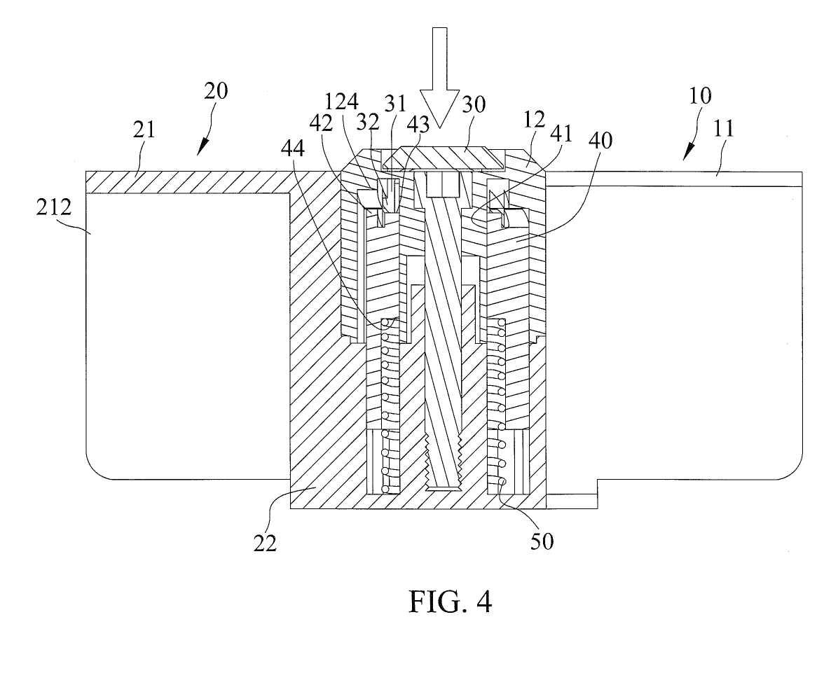

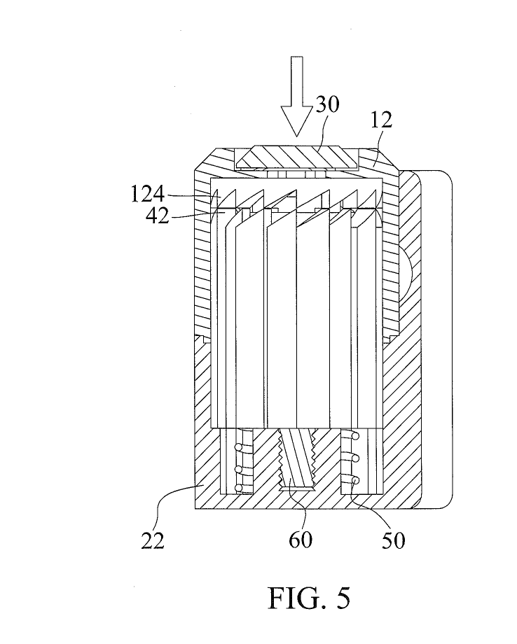

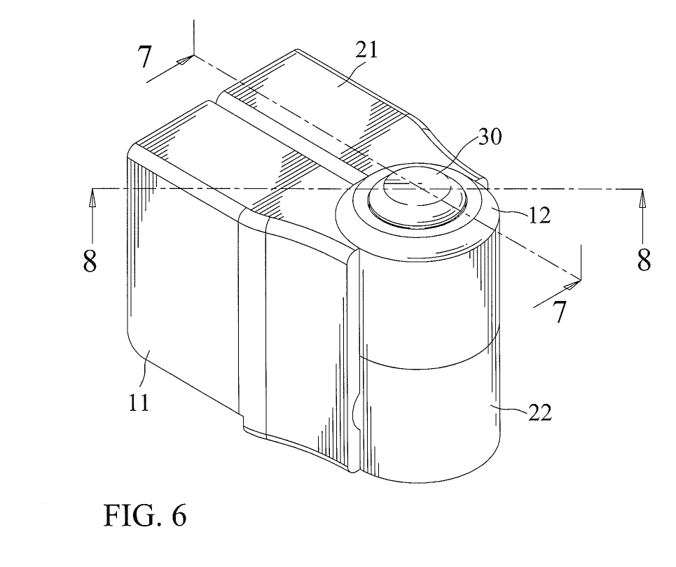

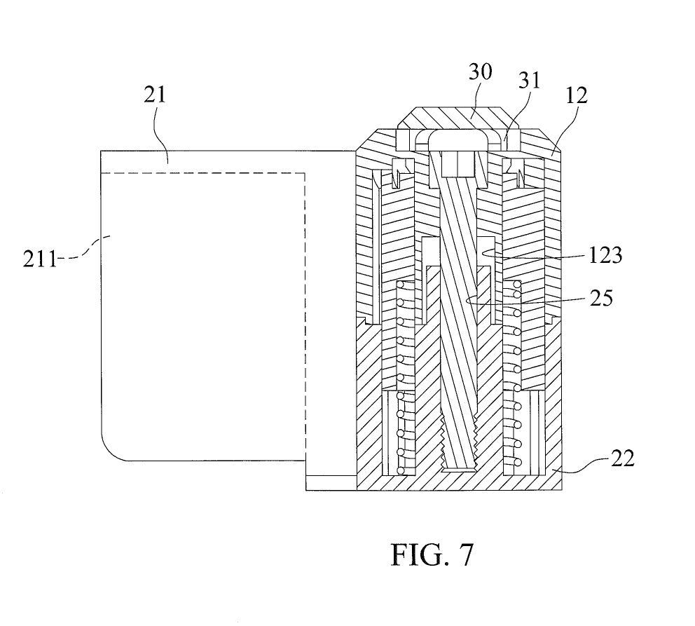

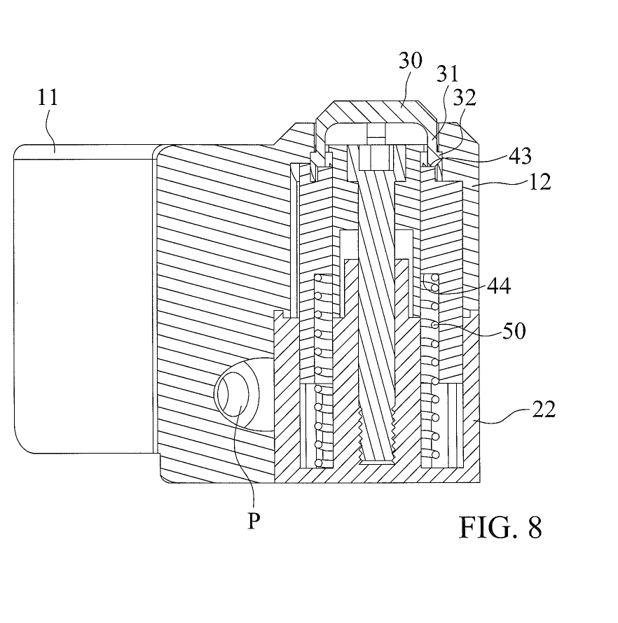

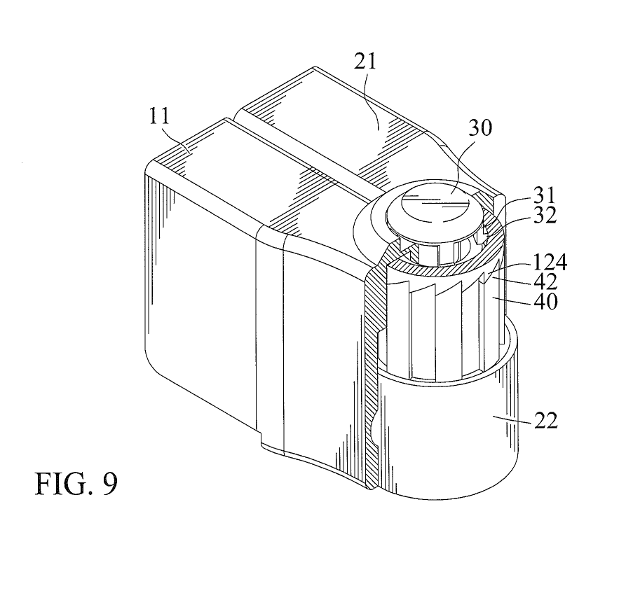

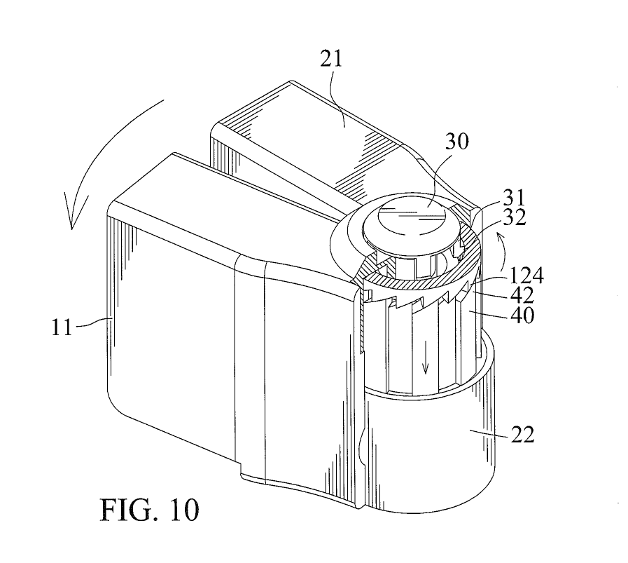

FIGS. 1 through 12 show a safety hinge mechanism in accordance with the present invention. The safety hinge mechanism includes first and second joining structures 10 and 20, an engaging member 40, and a biasing member 50.

The first joining structure 10 defines a first attaching end 11 for attaching a first external structure. The first attaching end 11 includes a first slot 111 with a first opening 112. The first opening 112 is adapted to allow the first external structure to be inserted into the first slot 111. The first slot 111 is adapted to include the first external structure disposed therein. The first joining structure 10 defines a first hinge end 12. The first hinge end 12 includes an inner periphery including a plurality of first engaging structures 124. Each of the plurality of first engaging structures 124 is in the form of a one-way clutch tooth. The plurality of first engaging structures 124 is circumferentially disposed.

The second joining structure 20 defines a second attaching end 21 for attaching a second external structure. The second attaching end 21 includes a second slot 211 with a second opening 212. The second opening 212 is adapted to allow the second external structure to be inserted into the second slot 211. The second slot 211 is adapted to include the second external structure disposed therein. Additionally, a thread hole P is extended in each of the first and second attaching ends 11 and 21. Each of the first and second external structures can be securely engaged with the respective first and second attaching ends 11 and 21 in a thread engagement. The second joining structure 20 defines a second hinge end 22. The second hinge end 22 is pivotally joined to the first hinge end 12. A fastener 60 is engaged with the first and second joining structures 10 and 20 for securely joining the first and second joining structures 10 and 20. The fastener 60 is extended through a bore 123 extended in the first hinge end 12, a hole 41 extended through the engaging member 40, and a receptacle 25 extended in a joint 24 extended from the second joining structure 20. The receptacle 25 defines an open port 28. The fastener 60 is inserted through the open port 28 into the receptacle 25. The receptacle 25 includes an inner thread 26 and the fastener 60 includes an outer thread 62 engaged with the inner thread 26. Further, a cavity 129 extended from an end of the bore 123. The cavity 129 is greater than the bore 123 in internal diameter. The fastener 60 includes a head 61 received and retained in the cavity 129.

A cap 30 is disposed outside the first hinge end 12 and received in a recess 121. The cap 30 includes a side including at least one leg 31. The at least one leg 31 is abutted against the engaging member 40. The at least one leg 31 is extended through at least one aperture 122 extended in the first hinge end 12. The at least one leg 31 includes a fixing structure 32 disposed outside the at least one aperture 122 and hooked to the first hinge end 12 for securely hooking the cap 30 to the first hinge end 12. The at least one leg 31 of the cap 30 is abutted against at least one protruding section 43 defined on an inner peripheral wall of the engaging member 40. The cap 30 is axially movable in the recess 121, with the engaging member 40 moving together. In the embodiment, the at least one leg 31 includes a plurality of legs 31. The plurality of leg 31 extends axially and is circumferentially disposed. Likewise, the at least one aperture 122 includes a plurality of apertures 122. The plurality of apertures 122 is circumferentially disposed.

The engaging member 40 includes an outer periphery including a plurality of second engaging structures 42 selectively engaged with the plurality of first engaging structures 124. Each of the plurality of second engaging structures 42 is in the form of a one-way clutch tooth. The plurality of second engaging structures 42 is circumferentially disposed. The plurality of second engaging structures 42 is extended outwardly from the inner peripheral wall of the engaging member 40. A first space 127 is disposed between an outer periphery of a wall 125 delimiting the bore 123 and a lateral side 126 of the inner periphery of the first hinge end 12. Further, a second space 23 is disposed between an outer periphery of the joint 24 and the lateral side of the inner periphery of the second hinge end 22. The engaging member 40 is received in the first and second spaces 127 and 23. Additionally, the first hinge end 12 includes an open end 128 and the engaging member 40 is partially extended outside the open end 128.

The engaging member 40 is axially movable between the first and second joining structures 10 and 20. The engaging member 40 is biased by the biasing member 50. The plurality of first and second engaging structures 124 and 42 are normally engaged with one another, and the biasing member 50 is not depressed when the engaging member 40 is in the first position. On the contrary, the biasing member 50 is depressed when the engaging member 40 is in the second position. An end of the biasing member 50 is received in the second space 23. Another end of the biasing member 50 is received in a recessed section 44 defined on the inner peripheral wall of the engaging member 40. The engaging member 40 is movable to a first position in which the first and second engaging structures 124 and 42 are engaged with and rotatable relative to one another in a first direction and anti-rotatable in a second direction reverse to the first direction and to a second position in which the first and second engaging structures 124 and 42 are disengaged from one another and rotatable relative to one another in both the first and second directions. The engaging member 40 is anti-rotated relative to the second hinge end 22. A lateral side of an inner periphery of the second hinge end 22 includes a plurality of third engaging structures 27 engaged with the plurality of second engaging structures 42.

The safety hinge mechanism is able to be extended and prevented from being collapsed when the engaging member is in the first position.

The safety hinge mechanism is able to be extended and collapsed when the engaging member is in the second position.

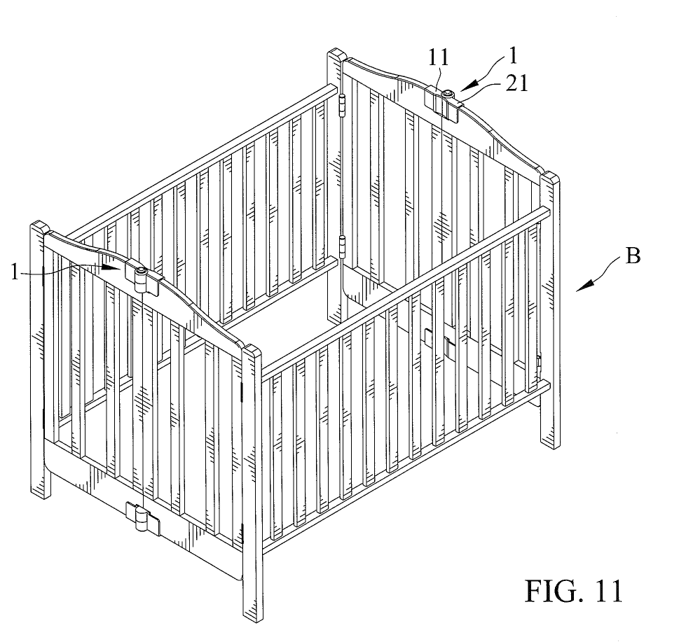

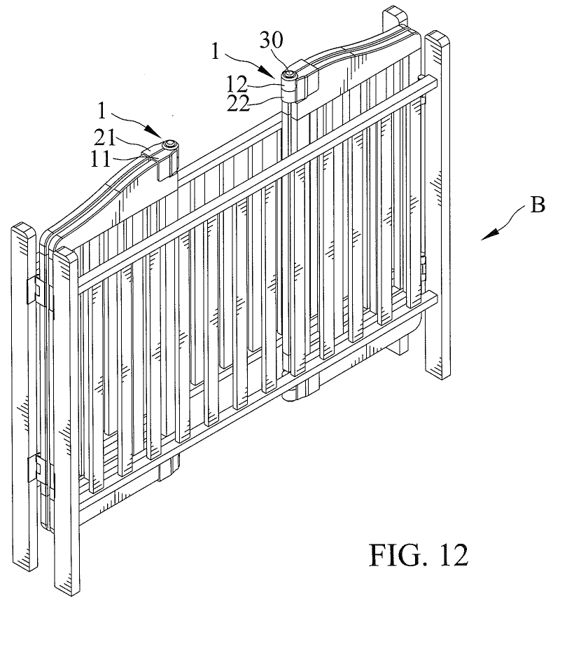

A maximum included angle between the first and second joining structures 10 and 20 is 180 degrees. FIGS. 11 and 12 show a cradle B includes a first fence structure attached to the first joining structure 10 and a second fence structure attached to the second joining structure 20. The first and second joining structures 10 and 20 has a first relative position in which an included angle between the first and second joining structures 10 and 20 is 180 degrees and the first and second fence structures are aligned with one another and in an extended position. The first and second joining structures 10 and 20 has a second relative position in which the first and second fence structures are overlapped and in a collapsed position.

In view of the foregoing, the safety hinge mechanism can prevent a user from getting hurt.

While the specific embodiments have been illustrated and described, numerous modifications come to mind without significantly departing from the spirit of invention, and the scope of invention is only limited by the scope of the accompanying claims.

What is claimed is:

1. A safety hinge mechanism comprising:
a first joining structure defining a first hinge end, with the first hinge end including an inner periphery including a plurality of first engaging structures;
a second joining structure defining a second hinge end, with the second hinge end pivotally joined to the first hinge end;
an engaging member axially movable between the first and second joining structures and including an outer periphery including a plurality of second engaging structures selectively engaged with the plurality of first engaging structures;
a biasing member biasing the engaging member;
wherein each of the plurality of first and second engaging structures is in the form of a one-way clutch tooth; and
wherein the engaging member is movable to a first position in which the first and second engaging structures are engaged with and rotatable relative to one another in a first direction and anti-rotatable in a second direction reverse to the first direction and to a second position in which the first and second engaging structures are disengaged from one another and rotatable relative to one another in both the first and second directions; and
wherein the safety hinge mechanism is able to be extended and prevented from being collapsed when the engaging member is in the first position; and
wherein the safety hinge mechanism is able to be extended and collapsed when the engaging member is in the second position.

2. The safety hinge mechanism as claimed in claim 1, wherein the engaging member is anti-rotated relative to the second hinge end, wherein a lateral side of an inner periphery of the second hinge end includes a plurality of third engaging structures engaged with the plurality of second engaging structures.

3. The safety hinge mechanism as claimed in claim 2 further comprising a cap disposed outside the first hinge end and received in a recess, wherein the cap includes a side including at least one leg, wherein the at least one leg is abutted against the engaging member, wherein the cap is axially movable in the recess, with the engaging member moving with the cap.

4. The safety hinge mechanism as claimed in claim 3, wherein the at least one leg of the cap is abutted against at least one protruding section defined on an inner peripheral wall of the engaging member, wherein the plurality of second engaging structures is extended outwardly from the inner peripheral wall of the engaging member.

5. The safety hinge mechanism as claimed in claim 4, wherein the at least one leg of the cap is extended through at least one aperture extended in the first hinge end, wherein the at least one leg includes a fixing structure disposed outside the at least one aperture and hooked to the first hinge end for securely hooking the cap to the first hinge end.

6. The safety hinge mechanism as claimed in claim 5, wherein the at least one leg of the cap includes a plurality of legs, with the plurality of leg extending axially and circumferentially disposed, wherein the at least one aperture includes a plurality of apertures, with the plurality of apertures circumferentially disposed.

7. The safety hinge mechanism as claimed in claim 3 further comprising a fastener engaging with the first and second joining structures for securely joining the first and second joining structures, wherein the fastener is extended through a bore extended in the first hinge end, a hole extended through the engaging member, and a receptacle extended in a joint extended from the second joining structure.

8. The safety hinge mechanism as claimed in claim 7, wherein the receptacle includes an inner thread and the fastener includes an outer thread engaged with the inner thread.

9. The safety hinge mechanism as claimed in claim 7 further comprising a cavity extended from an end of the bore, with the cavity greater than the bore in internal diameter, wherein the fastener includes a head received and retained in the cavity.

10. The safety hinge mechanism as claimed in claim 1, wherein the plurality of first engaging structures is circumferentially disposed, wherein the plurality of second engaging structures is circumferentially disposed.

11. The safety hinge mechanism as claimed in claim 7 further comprising a first space disposed between an outer periphery of a wall delimiting the bore and a lateral side of the inner periphery of the first hinge end and a second space disposed between an outer periphery of the joint and the lateral side of the inner periphery of the second hinge end, wherein the engaging member is received in the first and second spaces.

12. The safety hinge mechanism as claimed in claim 11, wherein an end of the biasing member is received in the second space.

13. The safety hinge mechanism as claimed in claim 1, wherein an end of the biasing member is received in a recessed section defined on the inner peripheral wall of the engaging member.

14. The safety hinge mechanism as claimed in claim 1, wherein the first joining structure defines a first attaching end for attaching a first external structure and the second joining structure defines a second attaching end for attaching a second external structure respectively.

15. The safety hinge mechanism as claimed in claim 14, wherein the first attaching end includes a first slot with a first opening and the second attaching end includes a second slot with a second opening respectively, with the first opening adapted to allow the first external structure to be inserted into the first slot, with the first slot adapted to include the first external structure disposed therein, with the second opening adapted to allow the second external structure to be inserted into the second slot, with the second slot adapted to include the second external structure disposed therein.

16. The safety hinge mechanism as claimed in claim 1, wherein a maximum included angle between the first and second joining structures is 180 degrees.

17. The safety hinge mechanism as claimed in claim 1, wherein the plurality of first and second engaging structures are normally engaged with one another, wherein the biasing member is not depressed when the engaging member is in the first position, wherein the biasing member is depressed when the engaging member is in the second position.

18. The safety hinge mechanism as claimed in claim 1, wherein a cradle includes a first fence structure attached to the first joining structure and a second fence structure attached to the second joining structure, with the first and second joining structures has a first relative position in which an included angle between the first and second joining structures is 180 degrees and the first and second fence structures are aligned with one another and in an extended position, with the first and second joining structures has a second relative position in which the first and second fence structures are overlapped and in a collapsed position.
